(19) United States
(12) Patent Application Publication
(10) Pub. No.: US 2026/0202091 A1
(43) Pub. Date: Jul. 16, 2026

(54) FLUID HEATING DEVICE

(71) Applicant: Toshiba Lighting & Technology Corporation, Kanagawa (JP)

(72) Inventors: Masahiro DOI, Ehime-ken (JP); Masahiko TAMAI, Kanagawa-ken (JP); Kousuke UENO, Ehime-ken (JP); Yoshihiro KUSUHASHI, Ehime-ken (JP); Tsuyoshi OHASHI, Ehime-ken (JP); Akio TSUBOUCHI, Ehime-ken (JP); Satoko KATO, Ehime-ken (JP); Yumi MINEYAMA, Ehime-ken (JP); Misaki AONAMI, Ehime-ken (JP); Kairi TAMURA, Ehime-ken (JP)

(73) Assignee: Toshiba Lighting & Technology Corporation, Kanagawa (JP)

(21) Appl. No.: 19/266,105

(22) Filed: Jul. 10, 2025

(30) Foreign Application Priority Data
Jan. 14, 2025 (JP) 2025-004854

(51) Int. Cl. F24H 1/10; F24H 1/18

(52) U.S. Cl. CPC F24H 1/101; F24H 1/182

(57) ABSTRACT

A fluid heating device according to an embodiment includes: a housing having a space inside through which a fluid flows; and at least one heater provided inside the housing and presenting a plate shape. The heater extends from a first inner wall side of the housing toward a second inner wall side facing the first inner wall, and a space is provided between the heater and the second inner wall.

### CROSS-REFERENCE TO RELATED APPLICATION

This application claims the priority benefits of Japanese application no. 2025-004854, filed on Jan. 14, 2025. The entirety of the above-mentioned patent application is hereby incorporated by reference herein and made a part of this specification.

### BACKGROUND

### Technical Field

The embodiment of the disclosure relates to a fluid heating device.

### Description of Related Art

There is a fluid heating device that heats fluids such as gases like air or liquids like water. As fluid heating devices, for example, there are hot air devices that heat air, hot water devices that heat water, and the like.

As such a fluid heating device, for example, a fluid heating device equipped with a PTC (positive temperature coefficient) heater has been proposed. When current flows through the PTC heater, the temperature of the PTC heater rises according to the magnitude of the current. And when the temperature of the PTC heater exceeds the Curie temperature, the resistance value of the PTC heater becomes high, making it difficult for current to flow through the PTC heater, and the temperature rise of the PTC heater is suppressed. As the temperature rise of the PTC heater is suppressed and the temperature of the PTC heater decreases, it becomes easier for current to flow through the PTC heater, and the temperature of the PTC heater rises again. Thus, by using a PTC heater, the heating temperature may be self-controlled.

However, since the PTC heater indirectly heats the fluid through the heat exchange fins, there is a problem that it is difficult to achieve improvement of the heating efficiency of the fluid. Further, since a plurality of plate materials are three-dimensionally arranged in the heat exchange fins, there is a problem that miniaturization becomes difficult when using the PTC heater. Thus, development of a fluid heating device that may achieve improvement of heating efficiency of fluid and miniaturization has been desired.

### RELATED ART LITERATURE(S)

### Patent Literature

[Patent Literature 1] Japanese Patent Application Laid-Open (JP-A) No. 2014-054934.

The problem to be solved by the disclosure is to provide a fluid heating device that may achieve improvement of heating efficiency of fluid and miniaturization.

### SUMMARY

The fluid heating device according to the embodiment includes: a housing having a space inside through which a fluid flows; and at least one heater provided inside the housing and presenting a plate shape. The heater extends from a first inner wall side of the housing toward a second inner wall side facing the first inner wall, and a space is provided between the heater and the second inner wall.

### BRIEF DESCRIPTION OF THE DRAWINGS

FIG. 1 is a schematic cross-sectional view for illustrating a fluid heating device according to the embodiment of the disclosure.

FIG. 2 is a schematic plan view of the heater in FIG. 1 in the B-B line direction.

FIG. 3 is a schematic cross-sectional view of the heater in FIG. 2 in the C-C line direction.

FIG. 4 is a schematic plan view for illustrating a heater according to another embodiment.

FIG. 5 is a schematic plan view for illustrating a heater according to another embodiment.

FIG. 6 is a schematic plan view for illustrating a heater according to another embodiment.

FIG. 7 is a schematic cross-sectional view for illustrating a fluid heating device according to another embodiment.

### DESCRIPTION OF THE EMBODIMENTS

According to the embodiment of the disclosure, it is possible to provide a fluid heating device that may achieve improvement of heating efficiency of fluid and miniaturization.

The embodiment will be described below with reference to the drawings. It is noted that in each drawing, the same reference numerals are assigned to similar components, and detailed descriptions are omitted as appropriate.

Further, arrow X, arrow Y, and arrow Z in each figure represent directions orthogonal to each other. For example, the X direction may be the longitudinal direction (length direction) of the heater. For example, the Y direction may be the transverse direction (width direction) of the heater. For example, the Z direction may be the thickness direction of the heater.

The fluid heating device 1 according to this embodiment directly heats a flowing fluid 100. The fluid 100 may be, for example, gas (e.g., air) included in an environment where the fluid heating device 1 is provided, or liquid such as water or solution (e.g., coolant liquid). However, the type of the fluid 100 is not limited to those exemplified.

In the following, as an example, a fluid heating device 1 that heats air contained in the environment will be described.

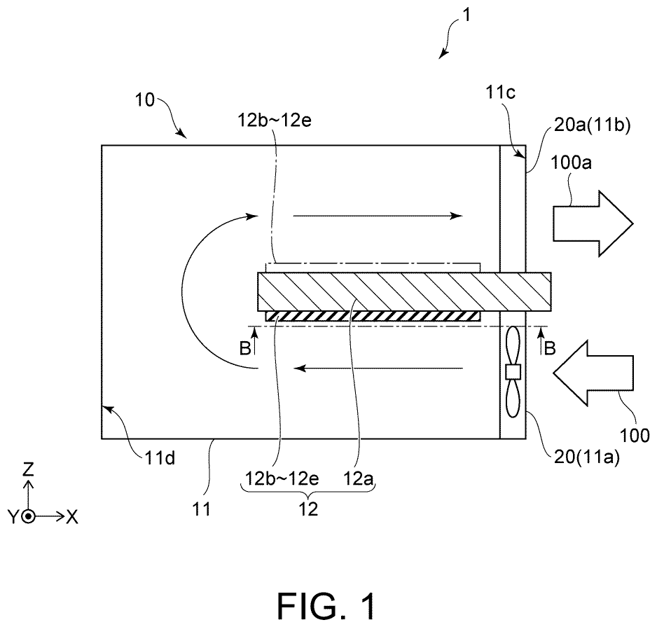

FIG. 1 is a schematic cross-sectional view for illustrating the fluid heating device 1 according to the embodiment of the disclosure.

As shown in FIG. 1, the fluid heating device 1 includes, for example, a heating portion 10 and a fluid supply portion 20.

The heating portion 10 includes, for example, a housing 11 and a heater 12. For example, the housing 11 has a space through which the fluid 100 flows inside. There is no particular limitation on the external shape of the housing 11. For example, the external shape of the housing 11 may be a rectangular parallelepiped, a cylinder, a prism, a sphere, or the like. The external shape of the housing 11 illustrated in FIG. 1 is a rectangular parallelepiped. Further, the housing 11 may be bent or curved. The external shape of the housing 11 may be appropriately changed according to the environment where the housing 11 is installed. The external dimensions of the housing 11 may be appropriately changed according to the space of the environment where the housing 11 is installed, the number and size of the heaters 12 to be provided, and the like.

The housing 11 is provided with a supply port 11a and a discharge port 11b. As shown in FIG. 1, the fluid 100 heated by the heater 12 is supplied to the inside of the housing 11 via the supply port 11a. The fluid 100a heated by the heater 12 is discharged to the outside of the housing 11 via the discharge port 11b.

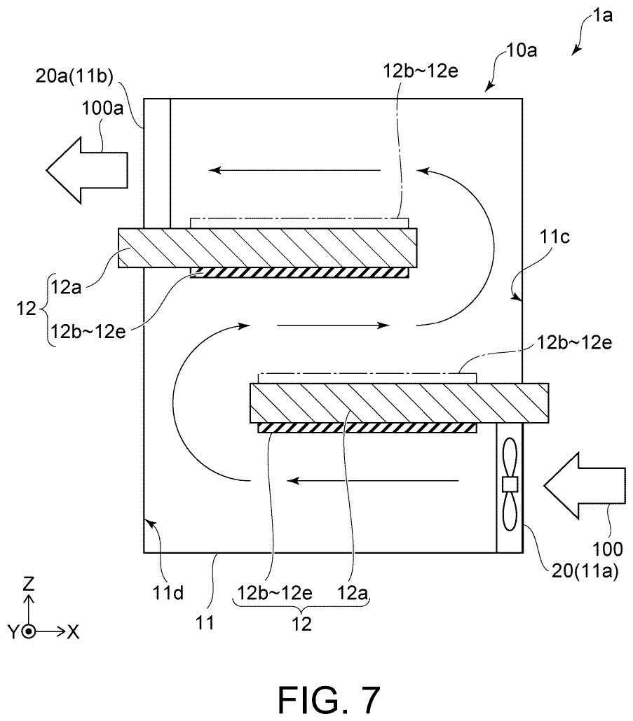

For example, when the number of heaters 12 is odd, as shown in FIG. 1, in the X direction (longitudinal direction of the heater 12), a supply port 11a and a discharge port 11b may be provided on a side portion of one side of the housing 11. When the number of heaters 12 is even, as shown in FIG. 7 described later, in the X direction (longitudinal direction of the heater 12), a supply port 11a may be provided on a side portion of one side of the housing 11, and a discharge port 11b may be provided on a side portion of the other side of the housing 11. For example, in the Z direction (thickness direction of the heater 12), the discharge port 11b may be provided at a position separated from the supply port 11a.

The material of the housing 11 is not particularly limited as long as it has a certain degree of rigidity and heat resistance. The material of the housing 11 may be, for example, a metal such as stainless steel, or a resin having heat resistance such as fluorine resin.

The heater 12 presents a plate shape and may be provided at least one inside the housing 11. The fluid heating device 1 exemplified in FIG. 1 is provided with one heater 12.

As shown in FIG. 1, the heater 12 extends in the X direction from the inner wall 11c (corresponding to an example of a first inner wall) side of the housing 11 toward the inner wall 11d (corresponding to an example of a second inner wall) side that faces the inner wall 11c. A space is provided between the heater 12 and the inner wall 11d.

Further, as shown in FIG. 1, in the thickness direction (Z direction) of the heater 12, the flow direction of the fluid 100 flowing along the heater 12 on the first side of the heater 12 is opposite to the flow direction of the fluid 100 flowing along the heater 12 on the second side of the heater 12 that faces the first side.

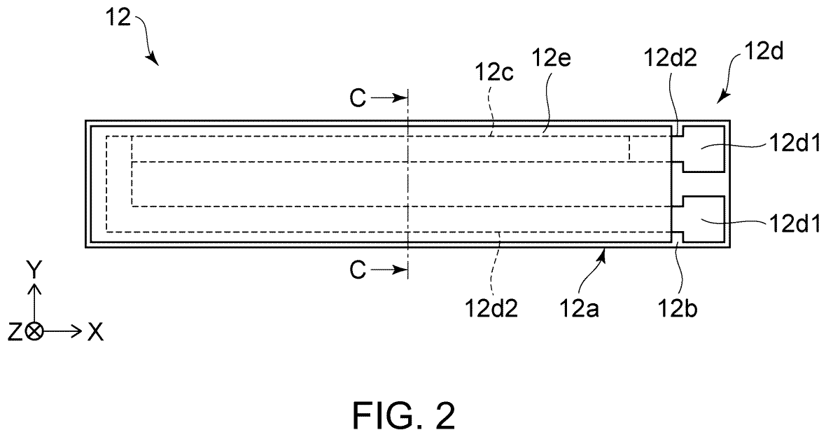

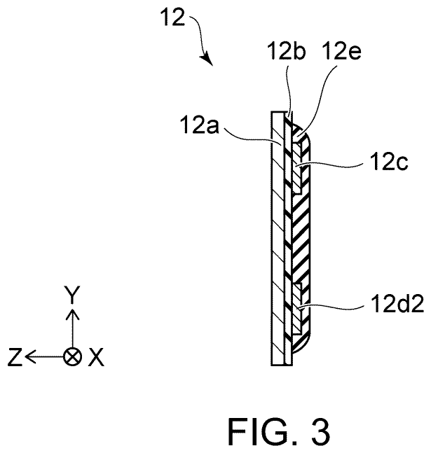

FIG. 2 is a schematic plan view of the heater 12 in FIG. 1 in the B-B line direction. FIG. 3 is a schematic cross-sectional view of the heater 12 in FIG. 2 in the C-C line direction. As shown in FIG. 2 and FIG. 3, the heater 12 includes, for example, a base portion 12a, an insulation portion 12b, a heating element 12c, a wire portion 12d, and a protection portion 12e.

For example, the base portion 12a presents a plate shape and extends in the X direction. The shape of the base portion 12a when viewed from the Z direction is, for example, rectangular. The dimension of the base portion 12a in the X direction and the dimension of the base portion 12a in the Y direction may be appropriately changed according to the internal dimensions of the housing 11. The dimension of the base portion 12a in the Z direction may be appropriately changed according to, for example, the magnitude of force applied to the heater 12 when the fluid 100 flows through the interior of the housing 11.

The base portion 12a is formed from a material having heat resistance. For example, the base portion 12a may be formed from metals such as stainless steel or aluminum alloy, or inorganic materials such as ceramics.

Here, the thermal conductivity of metal is higher than the thermal conductivity of inorganic materials such as ceramics. Thus, if the base portion 12a includes metal, it is possible to shorten the heating time of the heater 12 or improve the heating efficiency of the fluid 100. Moreover, the rigidity of metal is higher than that of inorganic materials such as ceramics. Thus, if the base portion 12a is formed from metal, it is possible to improve the rigidity of the heater 12. If it is possible to improve the rigidity of the heater 12, even if the flow velocity or flow rate of the fluid 100 is increased, it is possible to suppress damage to the heater 12.

On the other hand, inorganic materials such as ceramics generally have insulating properties. Thus, if the base portion 12a is formed from an inorganic material, the insulation portion 12b described later may be omitted. For example, when the base portion 12a is formed from a material having insulating properties, the heating element 12c and the wire portion 12d may be provided directly on the base portion 12a.

Moreover, if the base portion 12a is formed from a material having insulating properties, it is possible to suppress the occurrence of short circuits or electrical leakage.

The heater 12 illustrated in FIG. 2 and FIG. 3 is equipped with a base portion 12a including metal. Further, the heating element 12c and the wire portion 12d are provided on one side of the base portion 12a. The insulation portion 12b is provided between the heating element 12c and the wire portion 12d, and the base portion 12a.

The insulation portion 12b is provided, for example, on a surface on one side of the base portion 12a. The insulation portion 12b insulates between the base portion 12a having conductivity and the heating element 12c and the wire portion 12d. Thus, the insulation portion 12b covers at least a region where the heating element 12c and the wire portion 12d are provided on the surface on one side of the base portion 12a. The thickness of the insulation portion 12b is not particularly limited as long as insulation properties may be ensured. The thickness of the insulation portion 12b may be, for example, about 20 μm to 150 μm.

The insulation portion 12b is formed from a material having heat resistance and insulation properties. The insulation portion 12b includes, for example, ceramics, glass material, glass material to which filler containing inorganic material is added, oxides such as aluminum oxide, and the like. The insulation portion 12b may be formed by, for example, thermal spraying, firing method, anodizing treatment, etc.

The heating element 12c converts applied electric power to heat (Joule heat). For example, the heating element 12c presents a linear shape and extends in the longitudinal direction of the base portion 12a. The electrical resistance value per unit length of the heating element 12c may be made substantially uniform in the direction in which the heating element 12c extends, or may be made different. For example, the electrical resistance value per unit length of the heating element 12c illustrated in FIG. 2 is substantially uniform in the direction in which the heating element 12c extends. For example, the width dimension and thickness of the heating element 12c are substantially constant. When changing the electrical resistance value per unit length of the heating element 12c, at least one of the width dimension and thickness may be changed.

The heating element 12c may be formed using, for example, ruthenium oxide (RuO₂), silver-palladium (Ag—Pd) alloy, silver-platinum (Ag—Pt) alloy, etc. The heating element 12c may be formed by, for example, applying a paste-like material to the insulation portion 12b using a screen printing method etc., and curing this using a firing method etc. When the base portion 12a is formed from a material having insulating properties, the heating element 12c may be formed by, for example, applying a paste-like material to the base portion 12a using a screen printing method etc., and curing this using a firing method etc.

The wire portion 12d is provided on the base portion 12a via the insulation portion 12b. It is noted that when the base portion 12a is formed from a material having insulating properties, the wire portion 12d may be provided directly on the base portion 12a.

The wire portion 12d has, for example, a terminal 12d1 and a wire 12d2.

The terminal 12d1 is electrically connected to the heating element 12c via the wire 12d2. The terminal 12d1 may be provided, for example, as a pair. The terminal 12d1 may be provided, for example, in the vicinity of an end portion of the base portion 12a. In the heater 12 illustrated in FIG. 2, in the longitudinal direction of the base portion 12a, the pair of terminals 12d1 are provided in the vicinity of the end portion on one side of the base portion 12a.

The pair of terminals 12d1 are electrically connected to, for example, a controller or the like provided outside the fluid heating device 1 via a connector, external wiring, or the like. It is noted that the connection part between the terminals 12d1 and the external wiring may be covered with silicone resin or the like.

Further, as shown in FIG. 1, the end portion of the heater 12 on the side where the pair of terminals 12d1 are provided may also be exposed to the outside of the housing 11. If the pair of terminals 12d1 are exposed to the outside of the housing 11, it becomes easy to connect connectors, external wires, and the like to the pair of terminals 12d1.

Further, slots, connectors, and the like may be provided on the inner wall of the housing 11, and the end portion of the heater 12 on the side where the pair of terminals 12d1 are provided may be detachably provided in the slots, connectors, and the like.

The heater 12 may be detachably provided to the housing 11 using, for example, fastening members such as screws.

Further, the heater 12 (base portion 12a) may be fixed to the housing 11 or may be provided integrally with the housing 11. However, if the heater 12 is provided detachably to the housing 11, the maintainability of the fluid heating device 1 may be improved.

The wire 12d2 electrically connects the terminal 12d1 and the end portion of the heating element 12c. Thus, when the terminal 12d1 is directly connected to the end portion of the heating element 12c, the wire 12d2 may be omitted. However, when the heating element 12c extends in one direction, it is preferable to provide at least one wire 12d2. Thereby, it becomes easy to provide the pair of terminals 12d1 on one end portion side of the base portion 12a.

The terminal 12d1 and the wire 12d2 are formed using, for example, a material including silver or copper. For example, the terminal 12d1 and the wire 12d2 may be formed by applying a paste-like material to the insulation portion 12b using a screen printing method etc., and curing this using a firing method etc. In addition, when the base portion 12a is formed from a material having insulating properties, the terminal 12d1 and the wire 12d2 may be formed by, for example, applying a paste-like material to the base portion 12a using a screen printing method or the like, and curing this using a firing method or the like.

The protection portion 12e is provided on the base portion 12a, for example, via the insulation portion 12b. The protection portion 12e covers the heating element 12c and the wire 12d2. The terminal 12d1 is exposed from the protection portion 12e. It is noted that when the base portion 12a is formed from a material having insulating properties, the protection portion 12e is provided directly on the base portion 12a and covers the heating element 12c and the wire 12d2.

The protection portion 12e has, for example, a function of insulating the heating element 12c and the wire 12d2, a function of transmitting heat generated in the heating element 12c to the outside, and a function of protecting the heating element 12c and the wire 12d2 from external force and the fluid 100 that is the object of heating.

The protection portion 12e has heat resistance and insulation properties, and is formed from a material having high chemical stability and thermal conductivity. The protection portion 12e is formed from, for example, a glass material. In this case, the protection portion 12e may also be formed using a glass material to which a filler containing a material having high thermal conductivity such as aluminum oxide is added. The thermal conductivity of the glass material with added filler may be, for example, 2 [W/(m·K)] or higher. The thickness of the protection portion 12e may be, for example, about 10 μm to 60 μm.

The protection portion 12e may be formed, for example, by applying a paste-like material to the insulation portion 12b, the heating element 12c, and the wire 12d2 using a screen printing method or the like, and curing this using a firing method or the like. When the base portion 12a is formed from a material having insulating properties, the protection portion 12e may be formed, for example, by applying a paste-like material to the base portion 12a, the heating element 12c, and the wire 12d2 using a screen printing method or the like, and curing this using a firing method or the like.

Further, the heater 12 may be further provided with a detection portion that detects the temperature of at least one of the fluid 100 and the heating element 12c. The detection portion may be, for example, a thermistor. The thermistor may be formed by, for example, applying a paste-like material to the insulation portion 12b using a screen printing method or the like, and curing this using a firing method or the like. It is noted that when the base portion 12a is formed from a material having insulating properties, the detection portion may be formed by, for example, applying a paste-like material to the base portion 12a using a screen printing method or the like, and curing this using a firing method or the like. The material of the thermistor may include, for example, manganese and cobalt, and at least one of copper and nickel.

Further, a wire portion electrically connected to the detection portion may be provided. The wire portion may have a terminal and a wire, similar to the aforementioned wire portion 12d. In this case, the protection portion 12e may cover the detection portion and the wire. The terminal may be exposed from the protection portion 12e. The detection portion is electrically connected to a controller or the like provided outside the fluid heating device 1 via, for example, a connector, external wiring, or the like.

It is noted that, although the heater 12 illustrated in FIG. 2 is provided with one heating element 12c, a plurality of heating elements 12c may also be provided. That is, at least one heating element 12c may be provided.

When providing a plurality of heating elements 12c, the plurality of heating elements 12c may be arranged with intervals in a direction intersecting with the direction in which the heating elements 12c extend. Further, when providing a plurality of heating elements 12c, the length, width dimension, and thickness of the heating elements 12c may be the same, or at least any of the length, width dimension, and thickness of the heating elements 12c may differ.

The number, arrangement, length, width dimension, and thickness of the heating elements 12c may be appropriately changed according to the heat generation amount required for the heater 12.

Further, the heating element 12c may be provided on two sides of the base portion 12a. For example, the heater 12 may have a base portion 12a including metal, a first heating element provided on a first side of the base portion 12a, a first insulation portion provided between the base portion 12a and the first heating element, a second heating element provided on a second side of the base portion 12a, and a second insulation portion provided between the base portion 12a and the second heating element.

That is, the heating element 12c may be provided on at least one side of the base portion 12a.

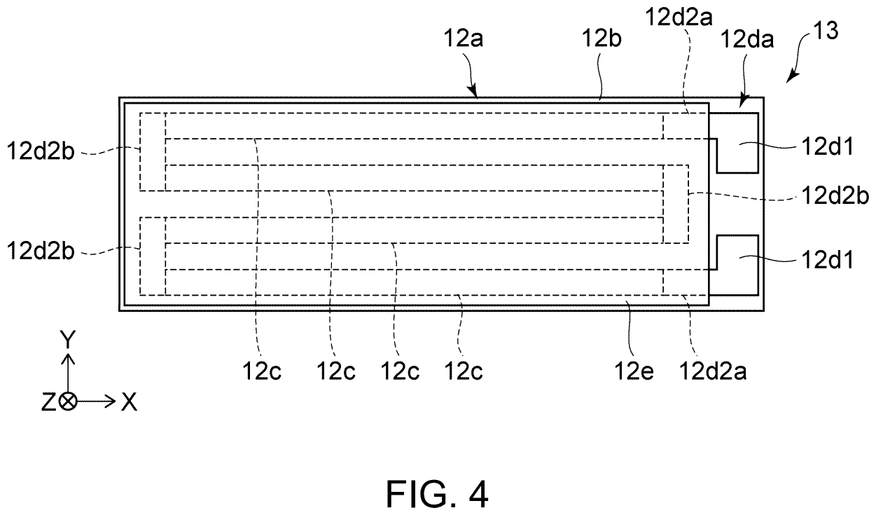

FIG. 4 is a schematic plan view for illustrating a heater 13 according to another embodiment.

As shown in FIG. 4, the heater 13 has, for example, a base portion 12a, an insulation portion 12b, a plurality of heating elements 12c, a wire portion 12da, and a protection portion 12e.

The heater 13 illustrated in FIG. 4 is provided with four heating elements 12c. Each of the four heating elements 12c extends in the X direction. The four heating elements 12c are provided arranged with intervals in the Y direction. In the heater 13 illustrated in FIG. 4, the four heating elements 12c have the same length, width dimension, and thickness.

The wire portion 12da has, for example, terminals 12d1, wires 12d2a, and wires 12d2b.

The wires 12d2a electrically connects the pair of terminals 12d1 and the heating elements 12c. It is noted that when the terminals 12d1 are directly connected to the end portions of the heating elements 12c, the wires 12d2a may be omitted. However, if the wire 12d2a is provided, the arrangement of the pair of terminals 12d1 may be arbitrarily changed. Thus, it becomes easy to set the arrangement of the pair of terminals 12d1 in consideration of the wiring space around the heater 13, the workability of wiring work, and the like.

The wires 12d2b are provided to connect a plurality of heating elements 12c in series. In the heater 13 illustrated in FIG. 4, four heating elements 12c are connected in series by three wires 12d2b.

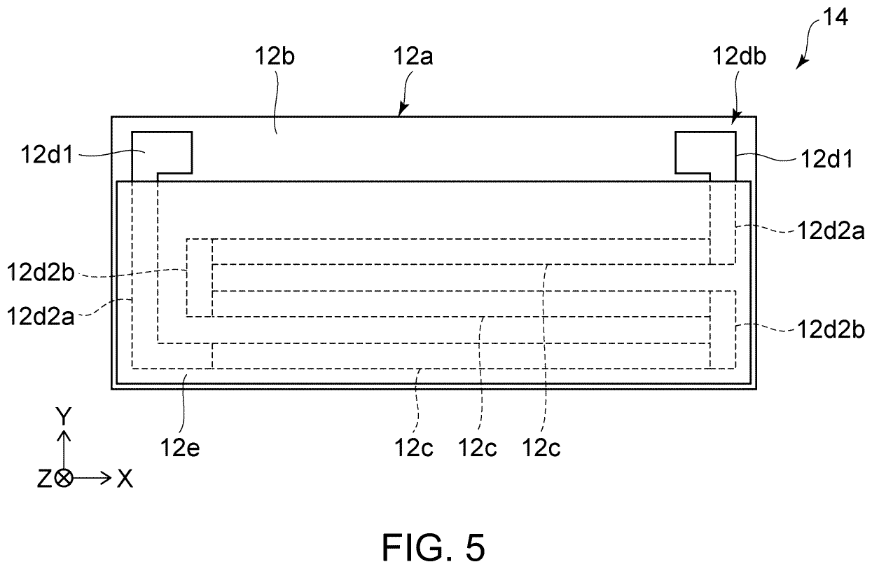

FIG. 5 is a schematic plan view for illustrating a heater 14 according to another embodiment.

As shown in FIG. 5, the heater 14 has, for example, a base portion 12a, an insulation portion 12b, a plurality of heating elements 12c, a wire portion 12db, and a protection portion 12e. In the case of the heater 14 exemplified in FIG. 5, three heating elements 12c are provided. The wire portion 12db has, for example, terminals 12d1, wires 12d2a, and wires 12d2b.

In the case of the heater 12 exemplified in FIG. 2 and the heater 13 exemplified in FIG. 4, a pair of terminals 12d1 are provided in the vicinity of end portions of the heaters 12 and 13 in the X direction (longitudinal direction). Thus, the pair of terminals 12d1 provided on the heaters 12 and 13 may be exposed from side portions of the housing 11 in the X direction, or may be positioned in the vicinity of inner walls of the housing 11 in the X direction.

In contrast, in the case of the heater 14 exemplified in FIG. 5, a pair of terminals 12d1 are provided in the vicinity of end portions of the heater 14 in the Y direction (transverse direction). Thus, the pair of terminals 12d1 provided on the heater 14 may be exposed from side portions of the housing 11 in the Y direction, or may be positioned in the vicinity of inner walls of the housing 11 in the Y direction.

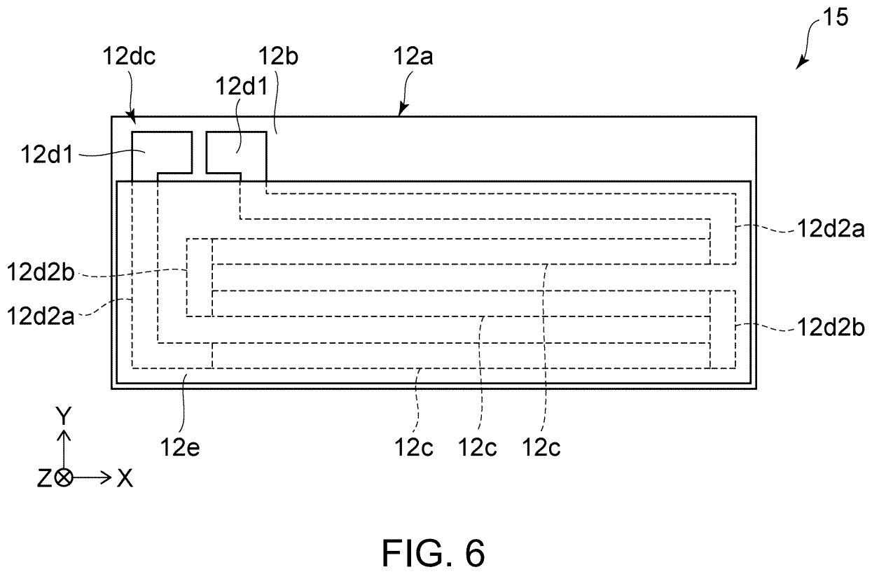

FIG. 6 is a schematic plan view for illustrating a heater 15 according to another embodiment.

As shown in FIG. 6, the heater 15 has, for example, a base portion 12a, an insulation portion 12b, a plurality of heating elements 12c, a wire portion 12dc, and a protection portion 12e.

As shown in FIG. 6, the wire portion 12dc has, for example, terminals 12d1, wires 12d2a, and wires 12d2b.

In the case of the heater 15 as well, similarly to the aforementioned heater 14, a pair of terminals 12d1 are provided in the vicinity of the end portions of the heater 15 in the Y direction (transverse direction). Thus, the pair of terminals 12d1 provided on the heater 15 may be exposed from side portions of the housing 11 in the Y direction, or may be positioned in the vicinity of inner walls of the housing 11 in the Y direction.

In this case, as described above, if the wire 12d2a is provided, the arrangement of the pair of terminals 12d1 may be arbitrarily changed. For example, as shown in FIG. 6, the pair of terminals 12d1 may be provided in proximity to each other. As described above, connectors, external wires, and the like are electrically connected to the pair of terminals 12d1. Thus, if the pair of terminals 12d1 are in proximity to each other, the wiring space around the heater 15 may be reduced, and the workability of wiring work may be improved.

It is noted that, in FIG. 6, a pair of terminals 12d1 are provided in proximity to each other in the vicinity of one end portion of the heater 15 in the Y direction, but the positions of the pair of terminals 12d1 are not limited thereto. For example, in the X direction, the pair of terminals 12d1 may also be provided in proximity to each other in a central region of the heater 15. The arrangement position of the pair of terminals 12d1 may be appropriately changed according to the space of the environment where the housing 11 is provided, the workability of wiring work, and the like.

The attachment of the heaters 13, 14, and 15 to the housing 11 and the wiring with controllers and the like may be the same as in the case of the heater 12 described above. Further, the heaters 12, 13, 14, and 15 may be used in combination.

Moreover, in the above, a case where a plurality of heating elements 12c are connected in series connection has been exemplified, but a plurality of heating elements 12c may be connected in parallel connection, or a plurality of heating elements 12c may be connected in series-parallel connection.

Further, although the heating element 12c extending in the X direction (longitudinal direction) of the base portion 12a is exemplified, a heating element extending in the Y direction (transverse direction) of the base portion 12a may also be provided. When providing a plurality of heating elements extending in the Y direction (transverse direction) of the base portion 12a, the plurality of heating elements may be provided arranged in the X direction. Further, the heating element may present a rectangular wave shape or a meandering shape.

As shown in FIG. 1, the fluid supply portion 20 supplies fluid 100 to the inside of the housing 11 from the supply port 11a of the housing 11. The fluid supply portion 20 may be, for example, an axial fan such as a propeller fan, or may be a centrifugal fan such as a sirocco fan. Although the case where the fluid supply portion 20 is provided at the supply port 11a of the housing 11 has been illustrated as an example, the fluid supply portion 20 may also be provided at a position separated from the housing 11 via, for example, a duct or the like.

Moreover, a finger guard 20a, for example, may y also be provided at the discharge port 11b of the housing 11.

Next, the operational effects of the fluid heating device 1 will be exemplified. It is noted that, in the following, the fluid heating device 1 provided with the heater 12 will be described, but the same applies to the case of the fluid heating device 1 provided with the heaters 13, 14, 15, heaters having different connection forms of the aforementioned heating element 12c, and heaters having different forms of the heating element 12c.

As shown in FIG. 1, the heater 12 is provided inside the housing 11. The heater 12 extends from one inner wall 11c side to the other inner wall 11d side of the housing 11 in the X direction. A space is provided between the heater 12 and the other inner wall 11d of the housing 11.

In the Y direction, the heater 12 may be brought into contact with the inner wall of the housing 11. Further, in the Y direction, a slight gap may be provided between the heater 12 and the inner wall of the housing 11.

Further, the heater 12 is provided between the supply port 11a and the discharge port 11b in the Z direction.

In this way, as shown in FIG. 1, a folded flow path is formed inside the housing 11 by the heater 12. In this case, the fluid 100 that flows along one side of the heater 12 in the Z direction, along the heater 12, from one end portion side of the heater 12 in the X direction toward the other end portion side, flows into the other side of the heater 12 in the Z direction via a space between the heater 12 and the inner wall 11d of the housing 11. The fluid 100 that flows into the other side of the heater 12 in the Z direction flows along the other side of the heater 12 in the Z direction, along the heater 12, from the other end portion side of the heater 12 in the X direction toward the one end portion side. That is, the flow direction of the fluid 100 is opposite between one side and the other side of the heater 12 in the Z direction.

Thus, the fluid 100 heated on one side of the heater 12 in the Z direction may be further heated on the other side of the heater 12, so that the heat transfer area of the heater 12 with respect to the fluid 100 may be increased, and the fluid 100 may be directly heated by the heater 12. Further, the heating efficiency of the fluid 100 may be improved without increasing the number of heaters 12. That is, with the fluid heating device 1 according to this embodiment, improvement of the heating efficiency of the fluid 100 and miniaturization may be achieved.

Here, the temperature of the fluid 100 flowing through the interior of the housing 11 in which the heater 12 is provided from the supply port 11a side toward the discharge port 11b side is lower on the upstream side than on the downstream side. Further, when the heating element 12c is provided on one side of the base portion 12a, the heat radiated to the side of the heater 12 where the heating element 12c is provided is more than the heat radiated to the side of the heater 12 opposite to the side where the heating element 12c is provided. Thus, it is preferable to provide the side of the heater 12 where the heating element 12c is provided on the upstream side of the folded flow path. By doing so, the low-temperature fluid 100 flowing on the upstream side of the folded flow path may be efficiently heated. Thus, further improvement of the heating efficiency of the fluid 100 may be achieved.

Further, if heating elements 12c are provided on two sides of the base portion 12a, the manufacturing cost of the heater becomes high, but compared to a case where two heaters each having a heating element 12c provided on one side of the base portion 12a are provided, miniaturization of the housing 11, and consequently miniaturization of the fluid heating device 1, may be achieved.

Further, as described above, since the thermal conductivity of metal is higher than the thermal conductivity of inorganic materials such as ceramics, by making the base portion 12a include metal, it is possible to shorten the heating time of the heater 12 or further improve the heating efficiency of the fluid 100.

Further, since the heater 12 presenting a plate shape is provided substantially parallel to the flow direction of the fluid 100, flow resistance may be reduced. Thus, it becomes easy to increase the flow rate or flow velocity of the fluid 100.

FIG. 7 is a schematic cross-sectional view for illustrating a fluid heating device 1a according to another embodiment.

As shown in FIG. 7, the fluid heating device 1a includes, for example, a heating portion 10a and a fluid supply portion 20.

The heating portion 10a includes, for example, a housing 11 and a plurality of heaters 12.

When providing a plurality of heaters 12, the plurality of heaters 12 may be provided arranged with intervals in the Z direction.
Further, when providing a plurality of heaters 12, a space is provided between the heater 12 and the inner wall 11d of the housing 11 in the X direction. Further, a space is provided between the heater 12 adjacent to the heater 12 in the Z direction and the inner wall 11c of the housing 11.

In this way, since the plurality of folded flow paths formed by the plurality of heaters 12 may be connected in series connection, a maze-like flow path may be formed inside the housing 11. Thus, it becomes easy to increase the temperature of the heated fluid 100a. Moreover, even in the case where the plurality of heaters 12 are provided, miniaturization of the fluid heating device 1a (housing 11) may be achieved.

It is noted that, in FIG. 7, the case where the heater 12 is provided is exemplified, but the same applies to cases where the heaters 13, 14, 15, heaters having different connection forms of the aforementioned heating element 12c, and heaters having different forms of the heating element 12c are provided.

As described above, several embodiments of the disclosure have been illustrated, but these embodiments are presented as examples and are not intended to limit the scope of the disclosure. Novel embodiments may be implemented in various other forms, and various omissions, replacements, and changes may be made without departing from the gist of the disclosure. These embodiments and the modified examples thereof are included within the scope and gist of the disclosure, as well as within the scope of the disclosure described in the claims and its equivalents. Further, the aforementioned embodiments may be combined with each other for implementation.

The following shows appendices regarding the aforementioned embodiment.

### (Appendix 1)

A fluid heating device, including: a housing, having a space inside through which a fluid flows; and
at least one heater, provided inside the housing and presenting a plate shape,
in which the heater extends from a first inner wall side of the housing toward a second inner wall side facing the first inner wall, and a space is provided between the heater and the second inner wall.

### (Appendix 2)

In the fluid heating device according to Appendix 1, in a thickness direction of the heater, a flow direction of the fluid flowing along the heater on a first side of the heater is opposite to a flow direction of the fluid flowing along the heater on a second side of the heater facing the first side.

### (Appendix 3)

In the fluid heating device according to Appendix 2, the heater includes:
a base portion, presenting a plate shape, extending in a direction in which the heater extends, and including metal;
a heating element, provided on the first side of the base portion; and
an insulation portion, provided between the base portion and the heating element,
in which the fluid that flows along the heater on the first side of the heater flows along the heater on the second side of the heater.

### (Appendix 4)

In the fluid heating device according to Appendix 1 or 2, the heater includes:
a base portion, presenting a plate shape, extending in a direction in which the heater extends, and including metal;
a first heating element, provided on the first side of the base portion;
a first insulation portion, provided between the base portion and the first heating element;
a second heating element, provided on the second side of the base portion; and
a second insulation portion, provided between the base portion and the second heating element.

### (Appendix 5)

In the fluid heating device according to any one of Appendices 1 to 4, a plurality of heaters are provided,
the plurality of heaters are provided arranged with intervals in a thickness direction of the heaters, and
in a direction in which the heater extends, a space is provided between a first heater and the first inner wall of the housing, and in a thickness direction of the heater, a space is provided between a second heater adjacent to the first heater and the second inner wall of the housing.

What is claimed is:

1. A fluid heating device, comprising:
a housing, having a space inside through which a fluid flows; and
at least one heater, provided inside the housing and presenting a plate shape,
wherein the heater extends from a first inner wall side of the housing toward a second inner wall side facing the first inner wall, and a space is provided between the heater and the second inner wall.

2. The fluid heating device according to claim 1, wherein in a thickness direction of the heater, a flow direction of the fluid flowing along the heater on a first side of the heater is opposite to a flow direction of the fluid flowing along the heater on a second side of the heater facing the first side.

3. The fluid heating device according to claim 2, wherein the heater comprises:
a base portion, presenting a plate shape, extending in a direction in which the heater extends, and comprising metal;
a heating element, provided on the first side of the base portion; and
an insulation portion, provided between the base portion and the heating element,
wherein the fluid that flows along the heater on the first side of the heater flows along the heater on the second side of the heater.

4. The fluid heating device according to claim 2, wherein the heater comprises:
a base portion, presenting a plate shape, extending in a direction in which the heater extends, and comprising metal;
a first heating element, provided on the first side of the base portion;
a first insulation portion, provided between the base portion and the first heating element;
a second heating element, provided on the second side of the base portion; and
a second insulation portion, provided between the base portion and the second heating element.

5. The fluid heating device according to claim 1, wherein a plurality of heaters are provided,
the plurality of heaters are provided arranged with intervals in a thickness direction of the heaters, and
in a direction in which the heater extends, a space is provided between a first heater and the first inner wall of the housing, and in a thickness direction of the heater, a space is provided between a second heater adjacent to the first heater and the second inner wall of the housing.
